(19) United States
(12) Patent Application Publication
(10) Pub. No.: US 2006/0242929 A1
(43) Pub. Date: Nov. 2, 2006

(54) Method and a device for controlled closing of containers with threaded caps

(75) Inventors: Giovanni Servadei, Faenza (IT); Claudio Fabbri, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: I.M.A. Industria Macchine Automatiche S.P.A., Ozzano emilia (IT)

(21) Appl. No.: 10/550,236

(22) PCT Filed: Mar. 24, 2004
(86) PCT No.: PCT/IB04/01051

§ 371 Date: Jun. 27, 2006

(30) Foreign Application Priority Data
Mar. 27, 2003 (IT) BO2003A000170

(51) Int. Cl. B67B 3/20

(52) U.S. Cl. 53/490; 53/331.5

(57) ABSTRACT

According to a method for controlled closing a container (1) with a related threaded cap (3), a container (1) is moved to a cap (3) feeding station, where a cap (3) in placed on the threaded upper end of the container (1). Then the container (1), together with the cap (3) is transferred to a closing station, where said cap (3) is screwed to said container (1). During screwing, the instant value of the torque applied to said cap (3) is measured and compared with a pre-selected threshold value, so ad to verify, in relation to the threshold value having been reached and to the moment, in which the value is reached, a stable tightening if the cap (3) onto the container (1).

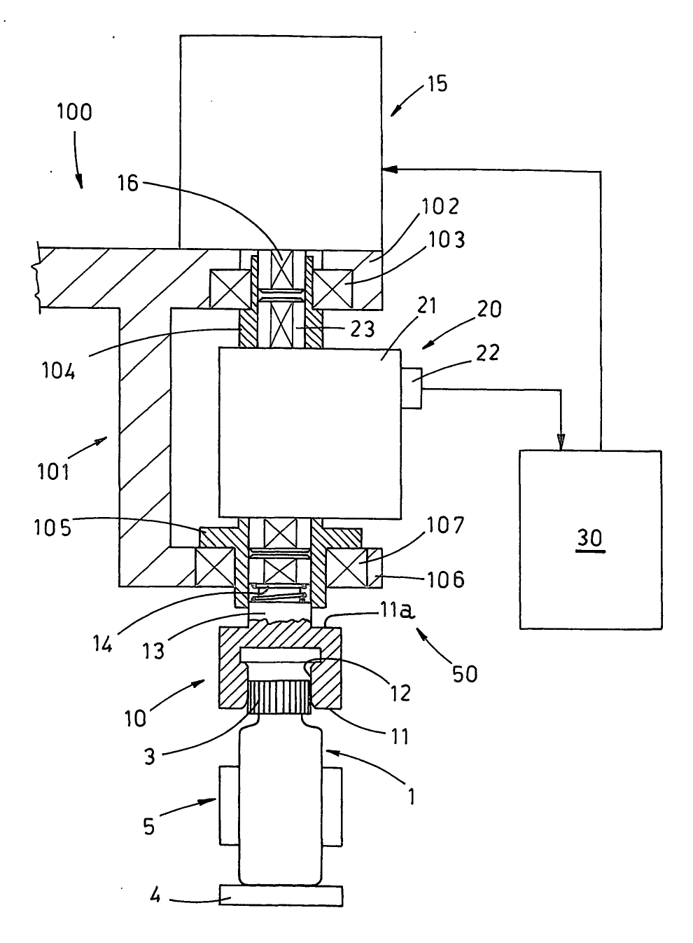

### BACKGROUND OF THE INVENTION

The present invention relates to automatic machines for packaging articles in containers, such as vessels or bottles.

In particular, the present invention is advantageously used in automatic packaging machines working in the field related to filling of bottles with liquid or powdery products, preferably in the pharmaceutical or cosmetic field, to which the following description will refer without losing the generality.

More specifically, the proposed invention relates to a method for controlling, directly in the production line, the correct closing of bottles by means of relevant screw caps in an automatic cap applying machine for closing bottles, and a device for carrying out this method.

### DESCRIPTION OF THE PRIOR ART

The automated closing of containers, such as bottles, by corresponding screw caps, is usually carried out in the production line, downstream of the bottles filling station and other stations, in which the threaded cap is put on the bottle neck, having a corresponding threading.

The cap is closed by a rotating chuck, which is situated on the bottle below, near the cap.

The bottles are usually held by clamping pliers, which prevent them from rotation.

In its lower part, the rotating chuck has a housing for receiving, with friction, the cap.

The chuck is keyed onto a shaft of a motor.

The motor is operated by a control unit to perform a predetermined number of revolutions, in order to screw the cap onto the bottle neck, until it is completely closed.

Then, the chuck is raised and a new bottle is fed therebelow, for a new closing operation.

The currently used cap applying machines do not allow a direct control of the bottle correct closure.

In particular, the cap must be tightened with a force greater than a predetermined value, in order to obtain a correct tight coupling between bottle and cap.

Actually, although for a definite number of threading turns a known number of closing turns is necessary to obtain an effective closure, an acceptable closure is not ensured by effecting this number of closing turns.

In fact, either the cap threading or the bottle neck threading could be damaged (the so-called “stripped” coupling), thus preventing completion of the screwing operation.

Moreover, mainly in case of cylindrical bottles, the pliers holding the bottle could be defective and could not completely avoid rotation of the bottle about its longitudinal axis.

In this case, the cap rotation by a prefixed number of turns would not complete the bottle closure, because the bottle would rotate together with the cap, at least partially.

Possible verifies can be performed from time to time, by sampling.

Previously closed bottles are withdrawn and opened out of line, by suitable apparatuses for measuring the torque necessary to unscrew the cap, so as to verify that the required tightening torque has been reached.

This verify method is usually destructive, because the caps are provided with breaking connections, which are broken by the first opening.

The correct closure of the bottles is extremely important in the pharmaceutical field, for obvious hygiene and asepsis reasons, which require perfect tightness of the coupling.

This safe closing is likewise necessary in this field, in order to obtain quality certificates for the products, which are packaged directly in the production line.

Otherwise, the above mentioned certificates can be obtained only by complicated and expensive verifies performed at the end of the production process.

### SUMMARY OF THE INVENTION

The main object of the present invention is to propose a method for verifying and identifying, directly in the production line, correct closing of the bottles with screw caps.

Another object of the present invention is to propose a method, which allows to perform the aforementioned control without affecting normal closure times.

A further object of the present invention is to propose a device, which controls and identifies, directly in the production line, the correct closure of the bottles with screw caps.

A still further object of the present invention is to propose a device, which can be applied to machines working either in a continuous, or in an intermittent way.

The above mentioned objects are obtained in accordance with the claims.

According to the present invention a method is disclosed for controlled closing of a container with a relative threaded cap, including moving said container to a cap feeding station, where said cap is placed on the threaded end of said container; the container, together with the cap associated thereto, is taken to a closing station, where said cap is screwed to said container; the method being characterized in that it includes also detecting, during the screwing step, the instant value of the torque applied to said cap and comparing the instant value with at least one pre-selected threshold value, in order to verify, in relation to said threshold value having been reached and to the moment, in which said value is reached, a stable tightening if said cap onto said container.

According to the present invention, a device is also provided for controlled closing of a container with a corresponding threaded cap including chuck means, which retain, with friction, a cap placed on a relative container; motor means, connected mechanically to said chuck means, to drive said chuck means and said threaded cap into rotation in a direction for screwing said cap to said container; the device being characterized in that it includes also means for torque detecting, situated between said motor means and said chuck means, to measure the instant value of the torque applied to said cap during rotation of the chuck means; and a control unit connected to said torque detecting means to receive from the latter said torque value and to compare it with a selected threshold value, and to verify, in relation with reaching of said threshold value and of the moment in which said value is reached, that said container has been firmly closed with said cap.

### BRIEF DESCRIPTION OF THE DRAWINGS

The characteristic features of the present invention, as resulting from the claims, will be pointed out in the following detailed description with reference to the enclosed drawing, which is a schematic lateral view, partially in section, of a preferred embodiment of a device for verifying and identifying correct closure of a bottle with a screw cap, which device carries out the method proposed by the invention.

### DISCLOSURE OF THE PREFERRED EMBODIMENTS

With reference to the above figure, the reference numeral 100 indicates a cap applying machine, for automated closing of containers 1, in particular bottles 1, with threaded caps 3.

The machine 100 is aimed at working in a line for packaging articles, for example pharmaceutical products in liquid or powder form, situated downstream of one or more stations for filling bottles 1 with the above articles.

The only part of the machine 100 shown in the figure is the frame 101, which supports a device 50 for closing bottles 1 with caps 3, obtained according to the present invention.

Pliers 5 convey the bottles 1, one after one, placed on a conveying surface 4, below the closing device 50, after relevant threaded caps 3 have been placed on the openings of the bottles 1.

The pliers 5 are also aimed at holding the bottle 1 in its position, and at preventing it from rotating on its longitudinal axis.

The closing device So include a chuck 10, which features a housing 12 formed in its lower surface 11 for receiving the cap 3 with a friction.

A motor 15, connected with the chuck 10 in coaxial relation, is operated by a control unit 30 to drive the chuck 10 into rotation.

Means 20 for detecting the torque are situated between the above mentioned chuck 10 and the motor 15, and are electrically connected to the control unit 30.

The means 20 are aimed at measuring the value of the instant torque during the chuck 10 rotation, in order to send it to the control unit 30 in form of a corresponding signal.

In particular, a stem 13 extends axially from the upper surface 11a of the chuck 10.

Shock absorbing means 14, situated inside the stem 13 according to a known technique, include a spring 14, which exerts its action axially and which is aimed at reducing the impact between the chuck 10 and the cap 3.

The above mentioned means 20 for measuring the torque include a torque transducer 20, connected axially with the shaft 16 of the motor 15, and at the other end, to the stem 13 of the chuck 10.

The inner structure and the operation principle of the transducer 20 are widely known, because they are normally on the marketplace, and consequently they will not be described in detail.

The transducer 20 is aimed at responding to the instant torque applied to the chuck 10, and consequently to the cap 3, and at proving at the output a measurable proportional electrical signal.

The body 21 of the transducer 20 has a pin 22, which sends the electric signal to the control unit 30.

The motor 15 is preferably a direct current positional controlled motor, like for example, an induction motor of the so-called “brushless” type.

With this type of motor, it is possible to know, with extreme precision, in every moment, the angular position of the shaft 16, and to set, with the same precision, the number of revolutions.

The body of the motor 15 is fastened to an upper cantilevered support 102 of the frame 101, and its shaft 16, supported rotatably by a first bearing 103, extends downwards through a hole made in the support 102.

The body 21 of the transducer 20 is mounted stationary with respect to the frame 101, and the upper end of its shaft 23 is connected to the shaft 16 of the motor 15 by a first sleeve 104.

The lower end of the shaft 23 is also connected to the shaft 13 of the chuck 10 by a second sleeve 105, in turn supported by a lower cantilevered support 106 of the frame 101 by a second bearing 107.

The control unit 30 includes substantially a processor with a stored program. The control unit can be an autonomous unit or a part of a more complex control unit of the machine 100 or of the packaging line (not shown).

The managing program of the control unit 30 includes a section aimed at allowing to set a given number of revolutions of the motor 15, or a prefixed period of time and speed for the motor rotation.

This section includes also setting a threshold value for the screwing torque, a comparison of the above mentioned value and the screwing torque value received from the transducer 20, and verifying, in relation to the reaching or exceeding the threshold value and the moment in which it has occurred, that the bottle 1 has been closed correctly with a stable tightening of the cap 3 onto the bottle 1.

In detail, the method for controlled closure of the bottle 1 with a threaded cap 3 includes the cyclical performing, for each bottle, of a series of operations described below.

A bottle 1, placed on the conveying surface 4, supported clamped by the pliers 5, is fed to the machine 100.

In a caps 3 feeding station, a threaded cap 3 is applied to the opening or to the upper threaded end of the bottle 1. Then the bottle and the cap are fed to a closing station, where the above described controlled closure device 50 is situated and acts, and is situated directly below the chuck 10.

According to a preferred embodiment of the method, the control unit 30 has been set up for a selected number of revolutions, in accordance with the cap 3 threading length, and for a prefixed threshold value of the torque applied to the chuck 10, and consequently to the cap 3.

On the basis of these settings, the motor 15 is operated into rotation for a prefixed number of revolutions, and at the same time, the transducer 20 immediately measures the applied instant torque and coverts it into a corresponding electric signal, which is sent to the control unit 30.

The settings are such that, after the set rotation has been completed, the cap 3 results firmly screwed to the bottle 1 up to the end, and resists to further rotation.

This way, the value of the torque measured by the transducer 20 increases, until it exceeds the prefixed threshold value.

Therefore, reaching the limit value, almost at the completion of the pre-set rotation, allows the control unit 30 to check the complete screwing of the cap 3 and consequently, the closure of the bottle 1.

According to an alternative embodiment of the method, the control unit 30 sets the threshold value of the torsional torque and a prefixed period of the motor 15 rotation, in accordance with the cap 3 threading length and the rotation speed of the motor 15.

In this case, the cap is screwed onto the bottle 1 for the above prefixed period of time.

The correct closure of the bottle 1 is determined by the reaching or exceeding of the above mentioned threshold value almost at the end of the predetermined period of time.

For both embodiments of the method, two cases can occur, which can be detected by the control unit 30, when the bottle 1 is not closed successfully.

The first case occurs when the predetermined rotation, or the predetermined rotation time, is finished, and the threshold value of the torque has not been reached in any moment of the rotation.

This means, first of all; that the cap 3 has rotated idly on the corresponding threading of the bottle 1, i.e. that the threaded coupling is “stripped”.

Otherwise, particularly in case of a cylindrical bottle, it could mean that the pliers 4 fail to prevent bottle rotation, and the bottle tends to rotate together with the cap 3.

Nevertheless, in both cases, the closing of the bottle 1 is not successful.

The second case occurs when the transducer 20 detects reaching or exceeding the threshold value by the instant value in a beginning or intermediate rotation step.

This means that the screwing of the cap 3 has not been completed, because the latter has stuck in the bottle 1, probably due to a defect of the threading or due to an error in the initial positioning of the cap.

Likewise, this closure defect can be detected by the device 50 of the controlled closure.

The advantages of the present invention result first of all from the possibility to check the correct closure of the bottles 1, immediately for each bottle and directly in the production line.

Moreover, this check is performed in a safe and not expensive way, because it requires the application of only small changes to the known closing devices.

Another advantage lies in the fact that the above mentioned checks are obtained without affecting in any way normal closure times, and thus without requiring more time.

A further advantage of the invention derives from the fact that the operations of the present method and of the device carrying out, are independent from other working modes of the production line.

Therefore, the method and the device can be used with capping machines working continuously, as well as with the ones working intermittently.

It is understood that what above, has been described as a pure, not limitative example, therefore, possible variants of the invention remain within the protective scope of the present technical solution, as described above and claimed hereinafter.

1. A method for controlled closing of a container (1) with a corresponding threaded cap (3), the method including:
moving said container (1) to a cap (3) feeding station, where a cap (3) is placed on a threaded end of said container (1);
taking said container (1) together with said cap (3) to a closing station, where said cap (3) is screwed to said container (1);
the method being characterized in that it further includes:
detecting, during the cap screwing step, the instant value of the torque applied to said cap (3) and comparing said instant value with at least one pre-selected threshold value, in order to verify, in relation with said threshold value having been reached and with the moment in which said value is reached, a stable tightening if said cap (3) onto said container (1).

2. A method as claimed in claim 1, characterized in that screwing action of said cap (3) to said container (1) is actuated for a selected number of turns, and that the correct closure of said container (1) is determined in relation to the reaching or exceeding of said selected threshold value of the torque, when the predetermined number of turns has been completed.

3. A method as claimed in claim 1, characterized in that screwing action of said cap (3) to said container (1) is actuated for a selected time, and the correct closure of said container (1) is determined in relation to the reaching or exceeding of said selected threshold value of the torque, when the selected time has elapsed.

4. A method as claimed in one of the previous claims from 1 to 3, characterized in that detection of the value of the torque includes converting thereof into an electric signal and sending this electric signal to a control unit (3), to evaluate the electric signal.

5. A device (50) for controlled closing of a container (1) with a corresponding threaded cap (3), the device including:
chuck means (10), which retain, with friction, a cap (3) placed on a relative container (1);
motor means (15), connected mechanically to said chuck means (10), to drive said chuck means and said threaded cap (3) into rotation in a direction for screwing said cap (3) to said container (1);
the device being characterized in that it further includes:
means (20) for torque detecting, situated between said motor means (15) and said chuck means (10), to measure the instant value of the torque applied to said cap (3) during rotation of the chuck means (10); and
a control unit (30) connected to said torque detecting means (20) to receive from the latter said torque value and to compare it with a selected threshold value, and to verify, in relation with reaching of said threshold value and of the moment in which said value is reached, that said container (1) has been firmly closed with said cap (3).

6. A device as claimed in claim 5, characterized in that said torque detecting means (20) include a torque transducer (20), connected to a shaft (16) of said motor means (15) and to a stem (13) of said chuck means (10), to convert the instant value of the torque applied to said cap (3) into a corresponding electric signal.

7. A device as claimed in claim 5 or 6, characterized in that said motor means (15) include an positional controlled electric motor

8. A device as claimed in one of the previous claims from 5 to 7, characterized in that said motor means (15) include an induction “brushless” motor.
